(19) United States
(12) Patent Application Publication
(10) Pub. No.: US 2014/0145541 A1
(43) Pub. Date: May 29, 2014

(54) BRUSHLESS DOUBLY FED MACHINES

(71) Applicants: Ehsan Abdi Jalebi, Cambridgeshire (GB); Richard Anthony McMahon, Cambridgeshire (GB); Peter John Tavner, Cambridgeshire (GB)

(72) Inventors: Ehsan Abdi Jalebi, Cambridgeshire (GB); Richard Anthony McMahon, Cambridgeshire (GB); Peter John Tavner, Cambridgeshire (GB)

(73) Assignee: WIND TECHNOLOGIES LIMITED, Cambridgeshire (GB)

(21) Appl. No.: 14/131,958

(22) PCT Filed: Jul. 11, 2012
(86) PCT No.: PCT/GB2012/051635

§ 371 Date: Jan. 10, 2014

(30) Foreign Application Priority Data
Jul. 15, 2011 (GB) 1112247.0

(51) Int. Cl. H02K 3/28; H02K 17/42

(52) U.S. Cl. CPC H02K 3/28; H02K 17/42
USPC 310/198

(57) ABSTRACT

We describe a brushless doubly fed machine (BDFM) comprising a stator having first and second sets of poles with p1, p2 respective numbers of pole pairs, and a rotor having (p1+p2) sets of electrically conducting loops. Each loop comprises a pair of conducting elements extending longitudinally along a direction of rotation of said rotor. Each said set of electrically conducting loops comprises at least first and second loops electrically connected in series with one another and at least one third loop configured to form a parallel load on said stator. An area encompassed by said third loop is less than an area encompassed by either of said first and second loops. Embodiments of this rotor design efficiently couple to two stator magnetic fields and suppress a space harmonic field.

### FIELD OF THE INVENTION

This invention relates to improved brushless doubly fed machines (BDFMs), which here includes brushless doubly fed induction generators (BDFIGs). More particularly the invention relates to improved rotor designs for such machines.

### BACKGROUND TO THE INVENTION

The generation of electricity from the wind is a proven means of obtaining energy without the emission of carbon dioxide. Wind turbines range from large machines with peak outputs of several Megawatts to small machines designed for domestic use. The most commonly used generator, at least in larger wind turbines, employs a wound rotor induction machine with a double feed. The rotor of the machine is wound with three-phase windings and connections are made to them by slip rings. In large wind turbines, a gearbox is generally used to increase the shaft speed at the blades, say 50 rpm, typically to 1000 to 1500 rpm to allow a 4 pole or 6 pole generator to be used. These are relative compact machines but the need for maintenance of brush gear is a major drawback, particularly offshore.

Recently, therefore, brushless doubly fed machines (BDFMs) have increasingly been considered because, as their name implies, they do not have brushes. The absence of brushes and slip rings makes the BDFM particularly attractive as a wind turbine generator as brush and slip ring problems in the widely used doubly-fed induction generator (DFIG) have been identified as a principal failure mode of these generators in wind turbines. Studies indicate that the combination of a BDFM and a two-stage gearbox would have excellent reliability and retain low cost. In these machines, there are two stator windings, one of which is connected directly to the fixed frequency mains and the other is supplied with a variable frequency and voltage from a power converter. The machines are run in a synchronous mode with a fixed relationship between the two stator frequencies and the shaft speed. Speed variation is achieved by changing the frequency applied to the second stator. The brushless doubly-fed machine (BDFM) is also of interest as a variable speed drive or generator because, in common with other doubly fed arrangements, only a fraction of the output power needs to pass through the converter.

A BDFM, in particular a single frame BDFM, has two stator windings of different pole numbers; alternatively a twin stator configuration can be used. In the case of the single frame BDFM, the pole numbers are chosen so that there is no direct coupling between them, the rotor coupling with both stator fields. One of the stator windings, the power winding (which has 2p₁ poles, i.e. p1 pole pairs) is connected to the power grid with a fixed voltage and frequency and the other, the control winding (which has 2p₂ poles, i.e. p₂ pole pairs) is supplied by a frequency converter with variable voltage and variable frequency. The frequency driving the control winding depends upon the rotor speed and is adjusted so that the frequency of the power winding output matches that of the grid, so achieving synchronous operation.

There are three principal types of brushless doubly-fed machines, the Brushless Doubly-Fed Induction Generator (BDFIG), the Brushless Doubly-Fed Reluctance Generator (BDFRG) (which has a reluctance type rotor), and the Brushless Doubly-Fed Twin Stator Induction Generator (BDFTSIG). Typically in a BDFG operation is via currents flowing in the rotor bars (which is not the case for a BDFRG where the rotor has salient poles). In both the BDFIG and BDFRG in general both stator windings are in a single frame, in general in the same slots, whereas a BDFTSIG has twin frames and two rotors on a common shaft. For a detailed classification and comparison of doubly-fed machines, reference can be made to: B. Hopfensperger and D. J. Atkinson, “Doubly-fed a.c. machines: classification and comparison,” in Proc. 9th. European Conf. Power Electronics and Applications, August 2001—and the specific definitions therein are hereby incorporated by reference. The techniques we describe later are especially useful with the brushless doubly-fed induction generator (BDFIG).

Further background information relating to brushless doubly-fed machines can be found in our earlier patent application WO2009/150464, and in the references therein.

The BDFM has its origins in the single-frame self-cascaded induction machine, in which two principal air-gap fields of different pole numbers share the same iron circuit. The contemporary BDFM typically has two separate stator windings with pole numbers chosen so that there is no direct coupling between them; that is coupling is via the rotor only. Separate stator windings facilitate double-feed, that is the connection of one winding directly to the grid and the other to the grid via a partially-rated electronic converter, without any penalty in winding utilization.

FIGS. 1a and 1b, taken from our WO2009/150464, show an outline block diagrams of brushless doubly fed machines (BDFMs) 100, 150 with, respectively, a 3-phase mains connection and a single phase mains connection. The BDFM has two stator windings, a power stator winding (S₁) which in embodiments is intended for direct connection to three-phase grid mains 102, and a control stator winding (S₂) which is connected to mains 102 via a (power) converter 104. The converter may be unidirectional (from the mains to the control winding) or, more usually, bi-directional, and may comprise a pair of series coupled AC-DC converters operating at a variable frequency on the machine side (to enable frequency control on this side) and at a fixed frequency on the line side (locked to the grid). The BDFM has a rotor 106 which may be driven via a gearbox (not shown) by a wind turbine. The BDFM may be, for example, a 4-pole/8-pole machine with a natural speed of 500 rpm or a 2-pole/6-pole machine with a natural speed of 750 rpm.

There is a need to improve BDFM performance, especially for larger machines, and the inventors have recognised that the rotor of a BDFM is a critical component. A good rotor will couple the two fields of interest and, broadly speaking, have low resistance and inductance. As shown in R. A. McMahon, P. C. Roberts, X. Wang, P. J. Tavner, “Performance of BDFM as generator and motor,” in IET Proceedings, Electric Power Applications, vol. 153, no. 2, pp. 289-299, 2006, there is a rotor turns ratio which maximizes the machine output. In addition, the rotor should be straightforward to manufacture. One approach uses two windings, one pitched for p1 pole-pairs and the other for p2 pole-pairs directly connected to each other, but this is wasteful of copper.

A better approach uses a nested loop type of rotor, comprising multiple loops in p1+p2 nests. The nested loop type of rotor is used in most BDFMs but the bars of a nested loop rotor must be insulated and manufacture is a relatively costly and time-consuming process. Depending on the number of of loops, space harmonic fields will be generated to a greater or lesser degree. The ratio of the principal fields to be adjusted to a certain extent The nested loop rotor also suffers from an unequal distribution of currents between the nested loops and there are circulating currents from mutual couplings between loops within a nest. Other forms of rotor winding have also been investigated. The analysis of these rotors is, however, complicated.

### SUMMARY OF THE INVENTION

According to the present invention there is therefore provided a brushless doubly fed machine (BDFM), the machine comprising a stator having first and second sets of poles with p1, p2 respective numbers of pole pairs, and a rotor having (p1+p2) sets of electrically conducting loops, each said loop comprising a pair of conducting elements extending longitudinally along a direction of rotation of said rotor, wherein each said set of electrically conducting loops comprises at least first and second loops electrically connected in series with one another and at least one third loop configured to form a parallel load on said stator, and wherein, preferably, an area encompassed by said third loop is less than an area encompassed by either of said first and second loops.

As previously mentioned, the rotor of a BDFM/BDFIG is an important element of the system, but is difficult to design rationally. The rotor couples to the two stator windings and should have a low resistance for low losses. There is also some benefit in having a low inductance, although the optimum inductance is also affected by Low Voltage Ride Through (LVRT) issues. Depending upon the application the requirement of LVRT is that the generator should stay connected when there is a grid fault resulting in a substantial drop in mains voltage; a higher rotor inductance can help to meet this requirement). There is also a desire to be able to adjust the rotor turns ratio, which represents a transformer effect between rotor-stator1 and rotor-stator2. A still further desire is space harmonic suppression, explained in more detail below.

In broad terms, harmonic leakage inductance (additional to the inherent inductance of a conducting loop) in the rotor reflects the appearance of ripple fields equivalent to higher numbers of pole pairs than the principal fields, in part because of ‘graininess’ resulting from the finite number of slots. This is especially a problem with a BDFM/BDFIG. For example a 2/4 pole pair machine has harmonics at respectively, 8, 14, 20 and higher multiples; and 10, 16, 22 and higher multiples of the pole pair numbers of the principal fields. The amplitude of these space harmonic fields broadly decays with higher harmonics, but not monotonically.

The inventors have recognised that, in broad terms, the larger loops on a rotor, which may be termed functional windings, are most important in performing an active role in coupling to the stator whereas smaller loops play only a small part in this but can be used as ‘damper windings’ to aid in suppressing unwanted space harmonic fields. Thus in broad terms in embodiments of the invention in a set of conducting loops the larger loops are used as functional windings and one or more smaller loops as damper windings. Because the rotor is effectively transformer coupled to the stator, separate conducting loops on the rotor are effectively connected in parallel, that is configured to form a parallel load on the stator in a similar manner to two windings on the same side of a transformer. Further, counter-intuitively, two (or more) of the functional windings are electrically connected in series with one another. Although this increases the total resistance, the number of effective turns is also increased and the effective load is reflected back to the ‘primary’ side of the transformer according to the square of the turns ratio. (Compare, conceptually two 1-turn windings each of resistance R on the secondary side with a 10:1 turns ratio giving two 100R reflective resistances in parallel on the primary side, with a 2-turn, 2R winding which is reflected as 25×2R on the primary side thus having an equivalent resistance). Series connecting the functional windings of the rotor has, by analysis, been found to lead in embodiments to around a 5% overall reduction in resistive losses.

Thus in embodiments of the invention two functional windings are series connected and at least one smaller damper winding is used to suppress undesired space harmonics. Overall p1+p2 sets of windings/circuits are provided, in embodiments evenly spaced. Embodiments of such designs provide a low overall resistance and a relatively low rotor inductance, the damper winding moderating the harmonic leakage inductance.

The overall number of windings may be determined according to a desired turns ratio for the BDFM/BDFIG, that is a desired coupling of the fields, essentially discounting the damper winding(s). The effective number of turns on the stator may be determined by a product of the number of turns per pole, a distribution factor (normally a little under unity) and a short pitching factor (normally a little under unity), representing the effect that using a pitch slightly less than 360°-divided-by-the-number-of-poles can help to reduce unwanted spatial harmonics.

In embodiments the third loop is nested within the first and second loops, which may themselves be nested. In embodiments the third loop is configured to have a useful overlap with a space harmonic field to be suppressed. For example if the third loop has conducting elements which are 10° apart this will couple well to a space harmonic defined by a sinusoid having a half wavelength of a similar length (angular extent), but a 5° half wavelength spatial harmonic will have both north and south components within the 10° span and thus will couple poorly to such a third loop. In embodiments where the rotor has a space harmonic field represented by a first sinusoid of unit amplitude at the first wavelength, and the third loop comprises conducting elements having an angular separation defining half a wavelength of a second unit amplitude sinusoid, the ratio of the integrals of the two sinusoids over a cycle is greater than a threshold, for example 0.1, 0.2 or 0.5. In embodiments the space harmonic field has space harmonic wavelengths equivalent to K1(p1+p2)+p1 and K2(p1+p2)+p2 pole pairs where K1 and K2 are integers. In embodiments multiple ‘third loops’, or damper windings, may be employed. The rotor may be provided with a plurality of discreet angular positions or slots circumferentially disposed around the (longitudinal) direction of rotation of the rotor. With such an arrangement conducting elements of different loops from the same or different sets may share angular positions/slots. The techniques we describe are particularly advantageous for larger BDFMs, for example greater than 1 MW output; these may have many slots (for example 60 slots with a 10° spacing). For such larger machines, even though the frequency of operation is low, of order mains frequency, the skin effect can nonetheless be significant. In such a case a conducting loop may be advantageously formed from a set of electrically conducting strips of rectangular cross-section mutually electrically insulated for increased surface area. These strips may be stacked to form the shape of a solid conducting bar.

Particularly where a winding comprises multiple conductors, conducting elements of different conducting loops may be substantially co-located at the same angular position or slot. For example half (or some other fraction) of a slot or position may be dedicated to series connected loops and the remainder to a ‘parallel’-connected loop. Thus, for example, there may be two second loops, one connected in series with the first loop and a the other, at substantially the same position, configured to form an independent parallel load (‘connected in parallel’) similarly there may be two first loops one electrically connected in series with a second loop, another independent and connected-in parallel. There may also be multiple third loops with overlapping conducting elements. For example instead of a single damper winding with a first angular spacing there may be two damper windings each half (or some other fraction) filling a central slot at half the angular spacing, for example two 10° windings with co-located conductors at a central position rather than a single 20° damper winding.

The invention also provides method of using a rotor winding of a BDFM to couple to two stator magnetic fields and suppress a space harmonic field, the method comprising using a rotor configuration as described above.

### BRIEF DESCRIPTION OF THE DRAWINGS

These and other aspects of the invention will now be further described, by way of example only, with reference to the accompanying figures in which:

FIGS. 1a and 1b show, respectively, example three-phase and single-phase mains connected brushless doubly-fed machines;

FIGS. 2a and 2b show, respectively, an example of a nested loop BDFM rotor and an example of a series wound BDFM rotor;

FIG. 3shows a per-phase equivalent circuit for a BDFM;

FIGS. 4a and 4b show winding arrangements for, respectively, a series loop wound rotor, and for a nested-loop rotor;

FIGS. 5a and 5b show, respectively, example cross-sections of wound BDFM rotors according to an embodiments of the invention; and a rotor winding arrangement according to an embodiment of the invention.

### DETAILED DESCRIPTION OF PREFERRED EMBODIMENTS

With copper-efficient BDFM rotor designs, such as the widely used nested loop configuration, harmonics of the two principal fields are generated at higher levels than found in conventional machine windings. For example the pitching of loops in the nested loop design leads to a substantial harmonic content in the air-gap. This will be reflected in an increase in leakage inductance of the rotor but couplings via harmonics to other loops and the stator windings will damp the amplitude of the harmonic fields to a degree. Also as machine size increases, the cross-section of the bars in a nested loop rotor will also increase, notwithstanding the greater number of rotor slots. A concern then arises about the skin effect, especially as the frequency of rotor currents will be a substantial fraction of the grid frequency. Under these conditions multiple conductors in each slot become desirable, and multilayer windings, such as the progressive loop winding in which a number of coils of equal span, advanced by a particular angular increment, are connected in series, become more realistic.

BDFM Design

We use symbols later as follows:

X1, X2, Xr indicating a stator1, stator 2, rotor quantity

p1, p2 stator winding pole-pair numbers

q phase number

f1, f2 supply frequency

s1, s2 slip

N, n turns (shaft speed) and turns ratio

Kw, kₚ winding and pitch factors

γ pitch angle

R, L resistance and inductance

Z impedance (of a rotor loop)

In general rotors will have p1+p2 sets of rotor circuits and each set may be a single winding or may have two or more independent circuits, as in the nested loop rotor. The BDFM has two stator windings on a common stator core, the windings being non-coupling through appropriate choice of poles. The rotor should couple both fields and rotor windings are discussed later. Stator winding non-coupling is satisfied if:

(i) p1 is even and p2 is odd or (ii) p1 and p2 are even as long as p1/p2 is not odd (p1/p2 does not need to be an integer)

Choosing pole-pair combinations that differ by two leads to unbalanced magnet pull so is best avoided.

Considering the windings for a 4-pole/8-pole BDFM, or 4/8 BDFM for short, illustrates the need to consider the connection of windings with care. The 8-pole field can never couple a coil fully pitched for four poles but coil pitched for 8-poles will respond to a 4-pole field and the elimination of cross-coupling relies on the series connection of coils to cancel the EMFs arising from the 4-pole field. Incorrect connection of the 8-pole coils would lead to severe circulating currents. Short pitching complicates the design as now there will be EMFs in the 4-pole coils resulting from the 8-pole field but coils can be connected in series to cancel these EMFs.

A further class of BDFMs, can be considered where cross-coupling EMFs do exist in each phase but they form a balanced set in a poly-phase machine. Machines with p1/p2=k where k is an odd integer fall into this category; an example is the 2/6 combination.

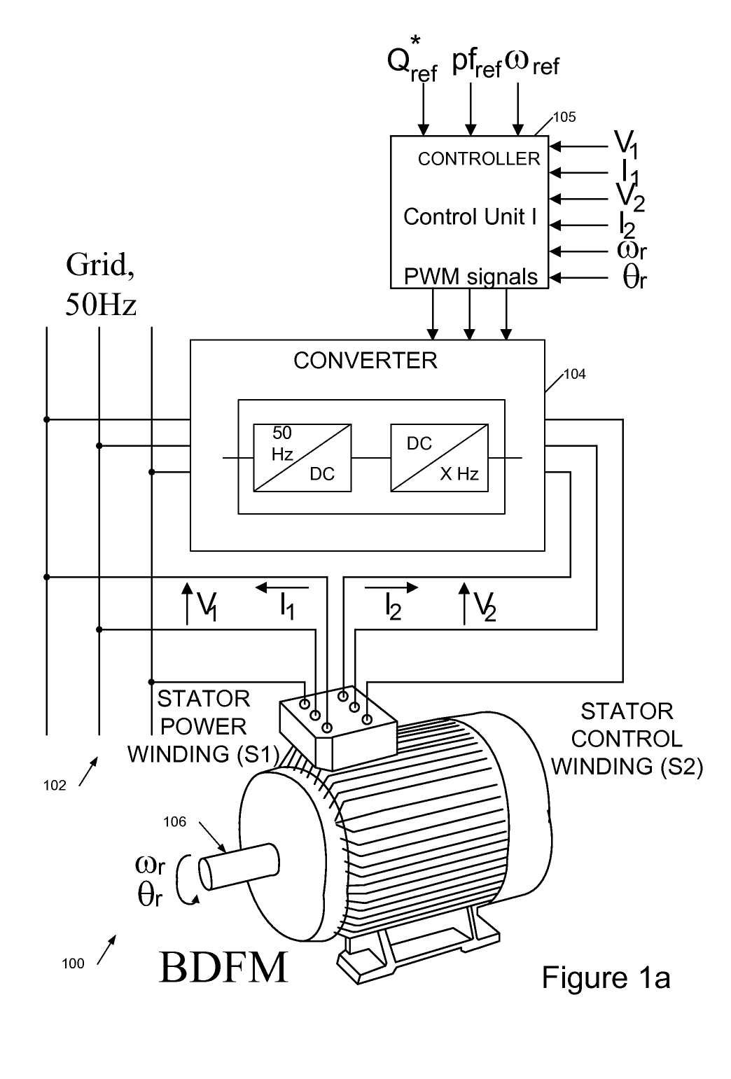

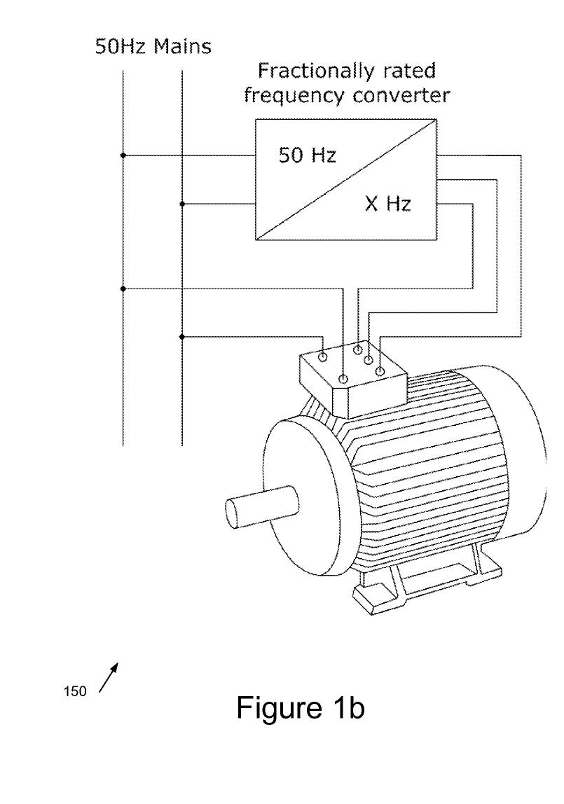

For controlled, variable speed operation the BDFM is operated in the synchronous, or doubly fed, mode. In this arrangement, as shown in FIG. 1, one winding, the power winding, is connected directly to the mains or grid. The other winding, the control winding is supplied with variable voltage at variable frequency from a converter connected to the mains or grid. There are also asynchronous modes. In the cascade mode the BDFM acts as a self-cascaded machine and this mode is useful for machine characterization and for starting.

The BDFM can be operated equally as a motor or generator. The relative power flows in the machine windings depend on whether the machine is motoring or generating, and whether it is running below, at or above natural speed. As a generator the power flows out of the control winding above natural speed and into this winding in motoring mode. The power flows in each case reverse below natural speed.

The rotor frequency will be a sizable fraction of the supply frequency, one third in a 4-pole/8-pole BDFM, and open rotor slots are therefore preferable. BDFMs are, in general, of the p1+p2, or cumulative type, but a p1−p2 form, the differential BDFM, is also possible. In the differential form of BDFM, the torques from the p1 and p2 fields oppose instead of aiding and this will lead to relatively high losses so this type of BDFM is unlikely to be of practical interest.

Although the BDFM works on induction principles, it is normally operated as a variable speed machine in the synchronous mode with double-feed, as shown in FIG. 1. In this respect, operation is the same as the widely used DFIG.

The shaft speed in the synchronous mode is given by

$$N = 60 \frac{{f}_{1} + {f}_{2}}{{p}_{1} + {p}_{2}} \qquad ( 1 )$$

In typical operation as a generator in a wind turbine, the speed range might be the natural speed +/−30%; a smaller range may well be adequate for pumping applications. A further relationship for the so-called natural speed, that is the synchronous speed when the control winding is fed with DC, is given by

$${N}_{n} = 60 \frac{{f}_{1}}{{p}_{1} + {p}_{2}} \qquad ( 2 )$$

The BDFM can also be operated in the self-cascaded mode in which one stator winding is shorted or in the simple induction mode with one stator winding open circuit. These two modes are useful for determining machine parameters.

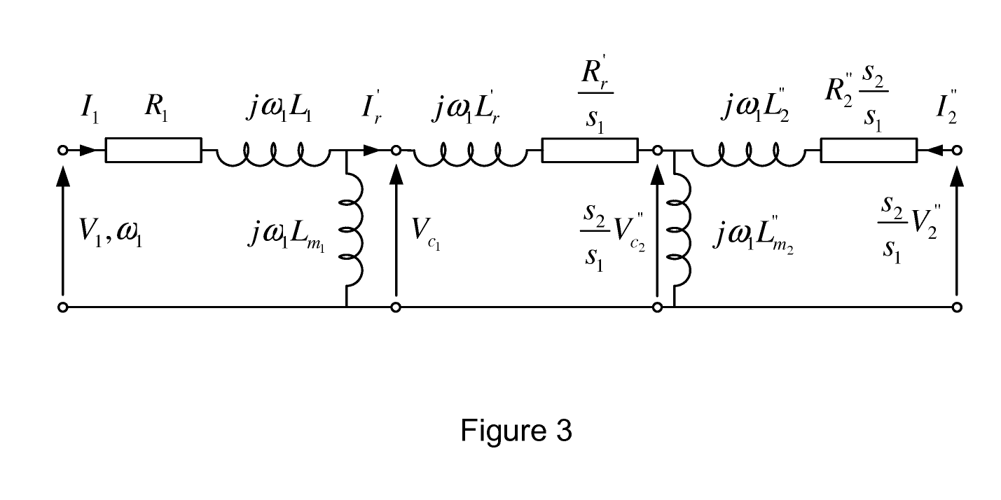

The operation of the BDFM can be described by a per-phase equivalent circuit of the form shown in FIG. 3a. Values are shown referred to the power winding and iron losses are neglected. R₁ and R₂ are the resistances of the stator windings and Rᵣ is the rotor resistance. Lₘ₁ and Lₘ₂ are the stator magnetising inductances, L₁ and L₂ are the stator leakage inductances and Lᵣ is the rotor inductance. The use of the modifier ‘′’ denotes that the quantity is referred. The slips s₁ and s₂ are defined as:

$$\begin{matrix}{s}_{1} = \frac{{f}_{1} {p}_{2} - {f}_{2} {p}_{1}}{{f}_{1}} ( {p}_{1} + {p}_{2} ) \\ and & ( 20 ) \\ {s}_{2} = \frac{{f}_{2} {p}_{1} - {f}_{1} {p}_{2}}{{f}_{2}} ( {p}_{1} + {p}_{2} ) & ( 21 )\end{matrix}$$

In most practical BDFMs the rotor leakage inductance is the largest series impedance term in the simplified equivalent circuit, and a core model retaining only this term may be used. This approach allows a number of useful relationships to be derived which assist in BDFM design. For normal operating conditions an optimum value of the rotor turns ratio nᵣ for maximum rating can be deduced, given by:

$${n}_{r} = {( \frac{{p}_{1}}{{p}_{2}} )}^{\frac{2}{3}} \qquad ( 3 )$$

BDFM Rotor Design

The following present ways of analysing rotor designs based on series and parallel nested loops, and by extension the method can be applied to combinations of series and parallel loops.

A. General Arrangement

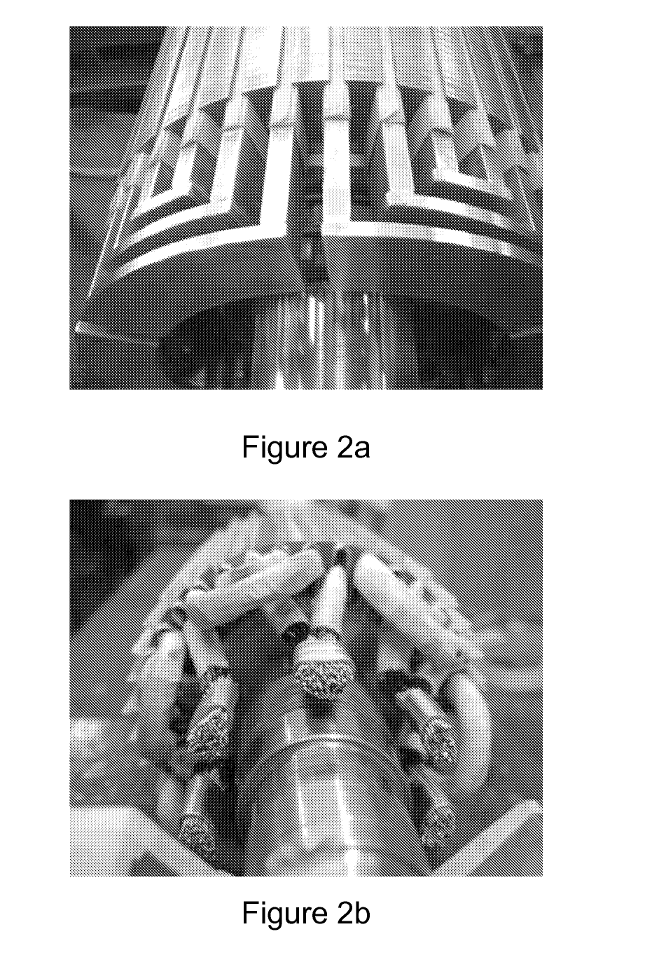

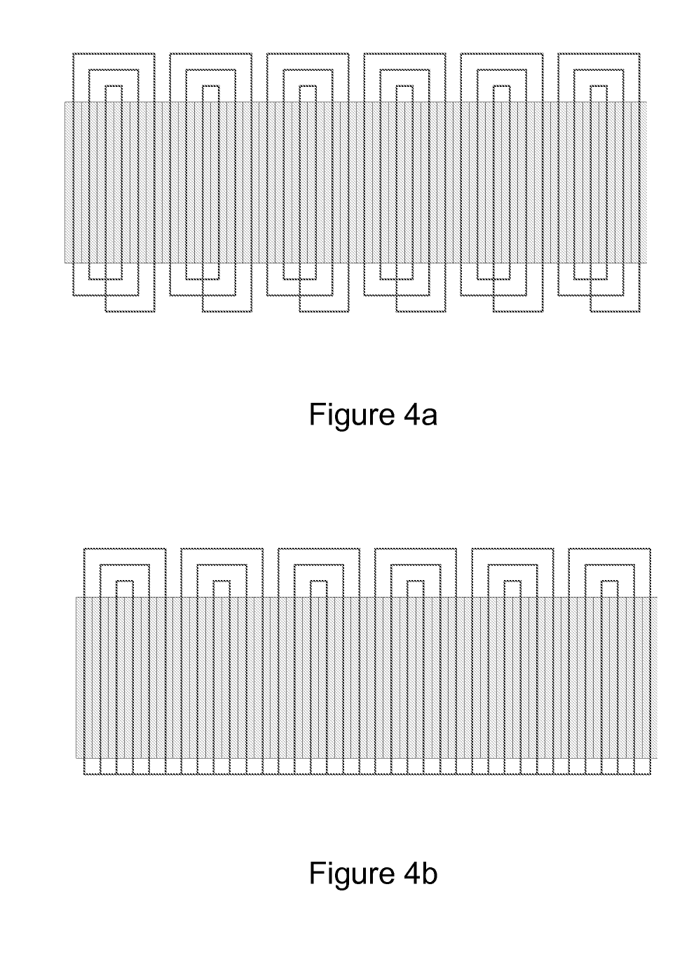

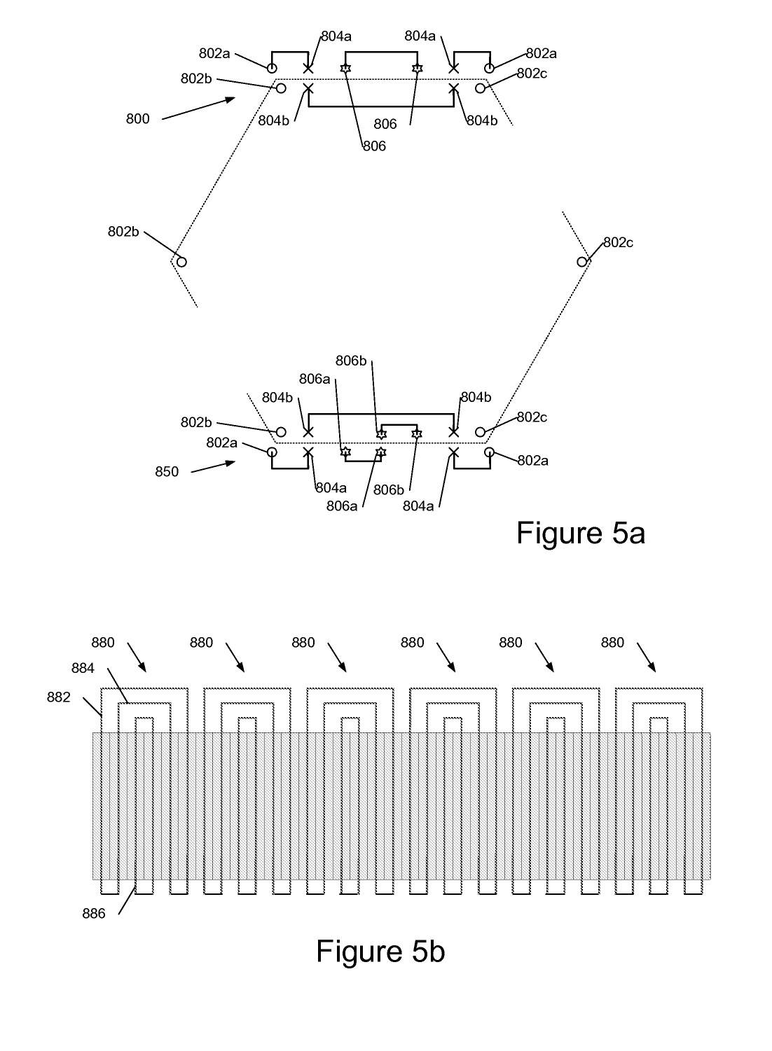

Rotors have been designed for use in a 4 pole/8 pole BDFM with 36 rotor slots. A p₁/p₂ pole-pair BDFM will have p₁+p₂ sets of rotor circuits, in this case six. A series loop wound rotor has three concentric coils in series in each set whereas the nested loop rotor has three concentric loops with a common shorting end ring, each set being distributed within a 60° arc, i.e. 360° divided by (p1+p2). The number of rotor slots must be an even multiple of six, hence the choice of thirty six slots The winding arrangements are shown in FIG. 4 and the prototype wound and nested-loop rotors are shown in FIG. 2.

Turns Ratio

Using equation (3) from above the optimum turns ratio for a 2/4-pole-pair BDFM is 0.5^{2/3} or 0.63. The turns ratio for the rotor is defined as

nr=(kw1r N1r)/kw2r N2r)
where the subscripts refer to the p1 and p2 principal fields and N are turns and kw the winding factors. As the same winding is producing mmfs for both the principal fields, the number of turns are the same, i.e. N1r=N2r. To find the actual turns ratio requires calculation of the effective turns for the coupling to the 4 and 8-pole fields. These are shown in Table II, noting that as the three series connected coils of one turn in each set are concentric the winding factors can be summed for the series loop wound rotor. The winding factors for each coil for the two couplings reduce to the pitching factor, that for pitch γ:

$$\begin{matrix}{k}_{{p}_{1}} = sin ( γ \frac{{p}_{1}}{2} ) & ( 4 ) \\ {k}_{{p}_{2}} = sin ( γ \frac{{p}_{2}}{2} ) & ( 5 )\end{matrix}$$

The spans of the three coils or loops are 10 deg, 30 deg and 50 deg. The sums of the winding factors are k_{wr1}=1.44 and k_{wr2}=2.19, which gives a turns ratio of 0.66, close to the optimum value of 0.63.

TABLE II
WINDING FACTORS FOR ROTOR LOOPS

| | | kw₁ 4- | kw₂ 8- |
|---|---|---|---|
| Coil/loop | Span γ | pole | pole |
| A Inner | 10 deg | 0.17 | 0.34 |
| B Middle | 30 deg | 0.5 | 0.87 |
| C Outer | 50 deg | 0.77 | 0.98 |
| N_{eff} | | 1.44 | 2.19 |

The loops in the nested loop rotor have mutual couplings which means that the calculation of the turns ratio is not straightforward. An approximation to the turns ratio for the nested-loop rotor can be found from considering an MMF balance with one stator open circuit as:

$${n}_{r} = \frac{\vert \frac{{kw}_{1 A} {kw}_{2 A}}{{Z}_{A}} + \frac{{kw}_{1 B} {kw}_{2 B}}{{Z}_{B}} + \frac{{kw}_{1 C} {kw}_{2 C}}{{Z}_{C}} \vert}{\vert \frac{{kw}_{2 A}^{2}}{{Z}_{A}} + \frac{{kw}_{2 B}^{2}}{{Z}_{B}} + \frac{{kw}_{2 C}^{2}}{{Z}_{C}} \vert} \qquad ( 6 )$$

where Z_{A}, Z_{B} and Z_{C} are the impedances of the rotor loops at a particular operating speed and the winding factors are as in Table II.

Providing that, as is usually the case, nᵣ does not vary significantly with speed, nᵣ can be conveniently evaluated at the natural speed, leading to a value for nᵣ of 0.69, again close to the optimum.

Parameter Calculation by Winding Factor Analysis

Parameters for the rotor are used to enable the performance of the overall machine to be predicted using the equivalent circuit. The rotor turns ratio has already been established

An estimate of the rotor resistance in the case of the series loop wound rotor can be found using the following relationship for each coil and adding the values. Particular account should be taken of the fact that the end-winding spans vary but the total arc length in the present winding is essentially the same as if the winding were concentric.

$${R}_{coil} = \frac{2 kN ρ}{A} ( \frac{π d γ}{360} + w ) \qquad ( 11 )$$

where N is the number of turns, ρ. the resistivity of copper (1.72×10⁻⁸ Ωm), A is the cross-sectional area of the conductor, d is the mean diameter of the rotor slots, w is the stack length and k is a constant, taken to be 1.1. It now remains to find the rotor inductance. This is made up of conventional leakage elements and harmonic inductance terms from the space harmonics created by the rotor. Some of the space harmonics will couple to the stator windings so the impedance presented to the rotor will not just be the magnetizing reactance for that space harmonic. However, an estimate of rotor inductance can be obtained by neglecting this effect.

The harmonic inductances can be found from:

$${L}_{h} = \frac{{μ}_{0}}{g} \frac{ldq}{π} {( \frac{{N}_{eff}}{p} )}^{2} \qquad ( 12 )$$

evaluated for the harmonic pole pair numbers. The effective turns are found for the pole number in question, g is the air-gap length and the other symbols have the same meaning as previously. The harmonic fields that can exist (harmonic order n) are given by

n ∈ {{p₁+m(p₁+p₂)}Y {p₂+m(p₁+p₂)}} (13)

where m is an integer. In reality, high pole number fields can only exist for point conductors so in evaluating the effective turns for a particular space harmonic, it is appropriate to assume that the conductor current density is uniformly distributed over a slot mouth giving a distribution factor kₛ

$${k}_{s} = \frac{sin ( {w}_{s} \frac{p}{2} )}{{w}_{s} \frac{p}{2}} \qquad ( 14 )$$

where wₛ is the angular width of the rotor slot mouth in radians.

Further Harmonic Considerations

The nested loop and related designs of BDFM rotor produce more harmonic fields than normal windings. On the basis that the stator windings in a BDFM are designed (as usual) to keep space harmonics to a low level, the rotor will be the dominant source of space harmonics. The fundamental component of rotor current, at a frequency fr, produces space harmonics of:

p=q(p1+p2)+p1 and p=q(p1+p2)+p2 pole pairs where q is an integer.

When q=0 this gives the wanted p1 and p2 fields; the other components are unwanted. Successive harmonics rotate in opposite directions. The amplitudes of the harmonics can in principle be calculated from the harmonic inductances of the rotor but this over-estimates their amplitude as the harmonic fields couple both within the rotor and via the stator.

Leakage Inductance

The space harmonic field looks like a leakage inductance. The leakage inductance components, ie. overhang, slot and zigzag (which may be found using the methods described in P. C. Roberts, “A study of brushless doubly-fed (induction) machines: Contributions in machine analysis, design and control”, Ph.D. dissertation, University of Cambridge 2004).

TABLE III
INDIVIDUAL LOOP PARAMETERS FOR THE NESTED LOOP
ROTOR

| Loop | A | B | C |
|---|---|---|---|
| Rᵣ | 105 | 118 | 132 |
| (μΩ) | | | |
| Lᵣ (μH) | 5.02 | 4.71 | 3.94 |
| Xᵣ (at | 1052 | 986 | 827 |
| natural | | | |
| speed) | | | |
| (μΩ) | | | |

The analysis of the nested loop rotor is complicated by the fact that there are three independent loops in each nest. The resistances of the individual loops in the nested loop rotor can be calculated using equation (11), ignoring the effects of the common end ring, and the harmonic inductance can be found using equation (12). The loops will have different winding factors for harmonic fields so there will be cross-coupling. To establish the range of possible rotor parameters, the evaluation has been carried out assuming no cross-coupling and assuming that the harmonics are fully damped. Reality is somewhere in between. Values of resistance, inductance and impedance evaluated at the natural speed (a frequency of 100/3 Hz) are shown in Table III and can be used to obtain values for Z_{A}, Z_{B} and Z_{C}. The physical dimensions of the machine used for these calculations can be found in R. McMahon, P. Tavner, E. Abdi, P. Malliband, D. Barker, “Characterising rotors for brushless doubly-fed machines (BDFM)”, in the Proceedings of XIX International Conference on Electrical Machines (ICEM2010), pp. 1-6, 2010.

Parameters for an equivalent single loop with a winding factor of unity can be determined by considering a short circuit on stator 2. The effective impedance of this loop Z_{eq} is

$${Z}_{eq} = {( \frac{{kw}_{1 A}^{2}}{{Z}_{A}} + \frac{{kw}_{1 B}^{2}}{{Z}_{B}} + \frac{{kw}_{1 C}^{2}}{{Z}_{C}} )}^{- 1} \qquad ( 15 )$$

Parameter Calculation by Coupled Circuit Analysis

Parameters can also obtained from coupled circuit analysis following the methodology given in P. C. Roberts, “A study of brushless doubly-fed (induction) machines: Contributions in machine analysis, design and control”, Ph.D. dissertation, University of Cambridge 2004). Importantly this method includes coupling via space harmonics.

Comparison of Calculated and Measured Parameters

A comparison of parameters obtained for the complete equivalent circuit is shown in Table IV for the series loop wound rotor and in Table V for the nested loop rotor. These are all referred to the power winding for comparison and are per-phase quantities based on a star connection. There are small differences between the calculated values for stator winding resistances, arising from the precise treatment of the end windings; the measured values are a little higher suggesting that there is more end winding overhang than is assumed in the calculations. The same effect is seen with the rotor resistance.

TABLE IV
COMPLETE PARAMETER SET FOR THE SERIES LOOP WOUND
ROTOR

| | Winding | | Coupled |
|---|---|---|---|
| | factor | Direct | circuit |
| Parameter | analysis | measurement | analysis |
| Rᵣ′ (Ω) | 2.80 | 3.11 | 2.76 |
| Lᵣ′ (mH) | 50.2 | — | 37.5 |
| N | 1.40 | — | 1.41 |

TABLE V
COMPLETE PARAMETER SET FOR THE NESTED LOOP
ROTOR

| | Winding | | Coupled |
|---|---|---|---|
| | factor | Direct | circuit |
| Parameter | analysis | measurement | analysis |
| Rᵣ′ (Ω) | 1.54 | — | 1.2 |
| Lᵣ′ (mH) | 49.9 | — | 21.2 |
| n | 1.33 | — | 1.35 |

In the case of the series loop rotor, the calculated values for the parameters related to the rotor, that is the turns ratio, rotor resistance and rotor leakage inductance, are close with the exception of the last mentioned. For the nested loop rotor, neglecting mutual coupling between loops via harmonics of the two principal fields in the winding factor method leads to differences in rotor parameter values, particularly in the leakage inductance. Coupling between loops reduces the harmonic leakage contribution substantially and modifies the effective resistance and turns ratio.

Series/Parallel Functional/Damping Winding Connection

The values for referred rotor parameters from Tables IV and V are compared in Table V. To make a fair comparison between the series and nested loop configurations, values with the fill factors of the slots has been made equal are also included. The nested loop rotor has significantly lower resistance, although with the adjustment to the fill factor the difference becomes negligible. However, as the structure of the nested loop rotor damps unwanted harmonics the overall rotor inductance is about half of that of the series loop configuration.

Also included in Table V are calculated values for a configuration in which the two outer loops of the series rotor are in series and the inner loop is connected effectively in parallel. This shows a reduction in resistance of approaching 10% relative to the nested loop design adjusted for slot fill factor. The rotor inductance is also significantly reduced by the parallel connected loop, to a value similar to that for the nested loop design. This is the motivation for series-connecting the outer, functional windings in embodiments of the invention.

TABLE V
PARAMETERS FOR SINGLE EQUIVALENT LOOPS

| | | | | 2 outer |
|---|---|---|---|---|
| | | | | lopps in |
| | | | Nested | series + |
| | | | loop | single |
| | Series | | reduced | inner |
| Rotor | loop | Nested loop | fill | loop |
| R′ᵣ (Ω) | 2.76 | 1.24 | 2.68 | 2.55 |
| L′ᵣ | 50.2 | 21.2 | 21.2 | 23.2 |
| (mH) | | | | |

### Example Embodiments of the Invention

Referring to FIG. 6a, this shows example cross-sections of wound BDFM rotors 800, 850 according to an embodiments of the invention. This figure shows partial cross-sections of two example rotor designs.

In the example embodiments a 4/8 BDFIG (p1=2; p2=4) has six sets of rotor circuits with 3 loops per set. In FIG. 6, however, for clarity, a complete view of just a single set of each example is shown; and the dashed hexagonal line is merely a guide to indicate the disposition of the windings.

The rotor design employs 60° outer (first) loops 802a sharing slots with adjacent outer loops 802b,c and series-connected with 40° span second loops 804a, these occupying 50% of the space in a slot. A single shorted loop 804b occupies the remaining 50% of the second loop slot space, acting as a further functional winding.

Then, in the example rotor 800, a 20° span single turn inner (third) loop 806 is added in parallel as a space harmonic damper (leaving a central 10° slot empty). In the alternative example rotor 850 the damper winding comprises two third loops 856a,b each of 10° span using a central slot and slots to either side.

FIG. 6b shows an electrical circuit of a rotor winding arrangement according to an embodiment of the invention. In the example of FIG. 6b, there are six sets of windings 880 each comprising three electrically conducting loops. First 882 and second 884 outer loops form series connected “functional” windings, and a third inner loop 886 is parallel connected (transformer coupled as a parallel load) and acts as a “damper” winding.

The skilled person will appreciate that other combinations of series/parallel connector loops may alternatively be employed in line with the basic idea of identifying two or more series connected loops that couple the two stator fields relatively well, and employing at least one third loop to suppress spurious space harmonic fields.

No doubt many other effective alternatives will occur to the skilled person. It will be understood that the invention is not limited to the described embodiments and encompasses modifications apparent to those skilled in the art lying within the spirit and scope of the claims appended hereto.

1. A brushless doubly fed machine (BDFM), the machine comprising a stator having first and second sets of poles with p1, p2 respective numbers of pole pairs, and a rotor having (p1+p2) sets of electrically conducting loops, each said loop comprising a pair of conducting elements extending longitudinally along a direction of rotation of said rotor, wherein each said set of electrically conducting loops comprises at least first and second loops electrically connected in series with one another and at least one third loop configured to form a parallel load on said stator, and wherein an area encompassed by said third loop is less than an area encompassed by either of said first and second loops.

2. A BDFM as claimed in claim 1 wherein said third loop is nested within said first and second loops.

3. A BDFM as claimed in claim 1 wherein said rotor has a space harmonic field represented by a first sinusoid of unit amplitude at a first wavelength, wherein said at least third loop comprises conducting elements having an angular separation defining half wavelength of a second sinusoid at unit amplitude, and wherein a ratio of integrals of said first and second sinusoids over a cycle is greater than 0.1.

4. A BDFM as claimed in claim 3 wherein said space harmonic field has harmonic wavelengths equivalent to K1(p1+p2)+p1 and K2(p1+p2)+p2 pole pairs where K1 and K2 are integers.

5. A BDFM as claimed in claim 1 comprising at lest two said third loops.

6. A BDFM as claimed in claim 1 wherein said rotor has a plurality of discrete angular positions around direction of rotation at which said conducting elements of said sets of electrically conducting loops are located, and wherein conducting elements of said first and second loops share a common said angular position.

7. A BDFM as claimed in claim 1 comprising two said second loops, a first said second loop connected in a series with said first loop and a second said second loop, substantially co-located with said first said second loop, and configured to form a parallel load on said stator.

8. A BDFM as claimed in claim 1 comprising two said third loops, wherein two of said conducting elements of said two third loops are substantially co-located in an angularly central position, and wherein each said third loop has a further conducting element to either side of said angularly central position.

9. A BDFM is claimed in any claim 1 wherein a said loop comprises a set of electrically conducting strips electrically insulated from one another.

10. A BDFM as claimed in claim 9 wherein said rotor has a plurality of slots along said direction of rotation of said rotor and circumferentially disposed at discrete angular positions around said direction of rotation, and wherein said conducting elements of said set of electrically conducting loops are located in said slots.

11. A method of using a rotor winding of a BDFM to couple to two stator magnetic fields and suppress a space harmonic field, the method comprising using a rotor configuration as recited in claim 1.
